(19) United States
(12) Patent Application Publication
(10) Pub. No.: US 2015/0355743 A1
(43) Pub. Date: Dec. 10, 2015

(54) TOUCH POINT POSITIONING DETECTION CIRCUIT, OPTICAL TOUCH PANEL AND DISPLAY DEVICE

(71) Applicants: HEFEI BOE OPTOELECTRONICS TECHNOLOGY CO., LTD., Hefei, Anhui (CN); BOE TECHNOLOGY GROUP CO., LTD., Beijing (CN)

(72) Inventors: ZUQUAN HU, BEIJING (CN); GUOLEI WANG, BEIJING (CN); MING HU, BEIJING (CN)

(21) Appl. No.: 14/370,434

(22) PCT Filed: Dec. 18, 2013
(86) PCT No.: PCT/CN13/89816

§ 371 Date: Jul. 2, 2014

(30) Foreign Application Priority Data
Aug. 1, 2013 (CN) 201310331811.5

(51) Int. Cl. G06F 3/042

(52) U.S. Cl. CPC G06F 3/042

(57) ABSTRACT

The present disclosure relates to a touch display technique field. There is disclosed a touch point positioning detection circuit, an optical touch panel and a display device, which are used for improving the touch accuracy of the touch panel. The touch point positioning detection circuit comprises: an optical touch sub-circuit for sensing a touch and generating a touch signal, an amplification sub-circuit connected to the optical touch sub-circuit for amplifying the touch signal, an output sub-circuit connected to the amplification sub-circuit for outputting the touch signal, and a detection sub-circuit connected to the output sub-circuit for determining a position of a touch point according to the outputted touch signal.

### TECHNICAL FIELD

The present disclosure relates to the field of touch display technique, in particular to a touch point positioning detection circuit, an optical touch panel and a display device.

### BACKGROUND

An in cell touch panel is a device that can realize functions of touching and image displaying by integrating a touch driving electrode and a touch sensing electrode into a display panel. The in cell touch panel may be categorized into a capacitive panel, a resistive panel and an optical panel and so on according to functions.

The capacitive and optical touch panels have been highly concerned because they can realize multi-point touch. The capacitive touch panel changes the size of electric field projected on the touch panel by using electric field of a human body, and determines a position of a touch point through detecting variation in current or voltage at the touch point. The optical touch panel determines the position of the touch point through detecting variation in current or voltage value caused by brightness of light on the surface of the touch panel.

The touch driving electrode and the touch sensing electrode of the in cell touch panel are integrated into the display panel, for example, being integrated into a color film substrate and/or an array substrate. The capacitive touch panel has a poor touch effect when the touch driving electrode and the touch sensing electrode are disposed in the array substrate or in a structure having a farther distance away from the surface at the light emitting side of the in cell touch panel. Due to the touch panel's requirement for operation and control within a relatively longer distance, an in-cell optical touch panel is capable of achieving a purpose of better touch effect, a thinner and lighter structure and a lower cost compared with other touch modes. Therefore, the in-cell optical touch panel has been attached increasingly importance.

As shown in FIG. 1, the touch point positioning detection circuit of the existing in-cell optical touch panel comprises: an optical touch sub-circuit 100 and an output detection sub-circuit 200. The optical touch sub-circuit 100 comprises a switch transistor (Photo TFT) being very sensitive to lights, a capacitor C1, and a switch transistor (Readout TFT) for controlling a signal to be outputted. Herein, both a gate and a source of the switch transistor Photo TFT are connected to a bias voltage (Bias) line; one terminal of the capacitor C1 is connected to the bias voltage (Bias) line and the other terminal thereof is connected to a source of the switch transistor Readout TFT (corresponding to node A in FIG. 1); a gate of the switch transistor Readout TFT is connected to a gate line (Select (n−1)) of the display panel, and a drain thereof is connected to a signal output line (Readout Line).

The switch transistors of Photo TFT and Readout TFT are n type transistors whose gates are switched on at a high level and switched off at a low level.

The operating principle of the circuit as illustrated in FIG. 1 is as follows: when the voltage on the Bias line is at a high level, the switch transistor Photo TFT is switched on, and the node A is charged to the high level; then, the voltage on the Bias line is changed from the high level to a low level. When Select (n−1) is changed to the high level, the switch transistor Readout TFT is switched on to transmit charges at the node A to the output detection sub-circuit 200 via the Readout Line of the switch transistor Readout TFT. The switch transistor Photo TFT is switched off if the touch panel does not have a strong light illuminating. At this time, when the switch transistor Readout TFT is switched on, the output detection sub-circuit 200 will detect a voltage value corresponding to the high level. The switch transistor Photo TFT is switched on if the touch panel has a strong light illuminating. At this time, the voltage on the Bias line is at the low level, the node A is discharged via the switch transistor Photo TFT, and the voltage at the node A is discharged to the low level. As a result, when the switch transistor Readout TFT is switched on, the output detection sub-circuit 200 will detect the voltage value corresponding to the low level, determine whether or not there is optical touch occurred to the touch panel by comparing variation in the voltage values before and after light illuminating, and thus determine the position of the touch point.

The touch point positioning detection circuit of the in-cell optical touch panel as illustrated in FIG. 1 that determines the position of the touch point has the following deficiencies: when there is an optical touch signal enabling the switch transistor Photo TFT to be switched on, the discharging capability at node A is weak, thereby the variation in the voltage values detected by the detection sub-circuit is not obvious in both cases that there is an optical touch and that there is no the optical touch, the accuracy for detecting the touch point by the detection sub-circuit to is not high, and the accuracy for the touch point positioning is not high.

### SUMMARY

Embodiments of the present disclosure provide a touch point positioning detection circuit, an optical touch panel and a display device, which are used for increasing the accuracy of touch point positioning of the optical touch panel.

The touch point positioning detection circuit provided in the embodiments of the present disclosure comprises an optical touch sub-circuit for sensing a touch and generating a touch signal, an amplification sub-circuit connected to the optical touch sub-circuit for amplifying the touch signal, an output sub-circuit connected to the amplification sub-circuit for outputting the touch signal, and a detection sub-circuit connected to the output sub-circuit for determining a position of a touch point according to the outputted touch signal.

Exemplarily, the optical touch sub-circuit comprises: a first switch transistor, a capacitor and a photosensitive capacitor;

wherein the first switch transistor has a gate and a source connected to a first reference voltage source, and a drain connected to one terminal of the capacitor; the other terminal of the capacitor is connected to one terminal of the photosensitive capacitor, and the other terminal of the photosensitive capacitor is connected to a second reference voltage source; and the amplification sub-circuit is connected to the terminal of the capacitor connected to the first switch transistor.

Exemplarily, the amplification sub-circuit comprises a second switch transistor, a third switch transistor and an amplification transistor;

wherein the second switch transistor has a gate connected to a terminal of the capacitor connected to the first switch transistor, and the third switch transistor has a gate connected to a terminal of the capacitor connected to the photosensitive capacitor; the second switch transistor has a drain connected to a drain of the third switch transistor, and a source connected to a high level voltage source; the third switch transistor has a source connected to a low level voltage source; and the amplification transistor has a gate connected to the drain of the second switch transistor, a drain connected to the output sub-circuit, and a source connected to a high level power supply voltage source.

Exemplarily, the output sub-circuit comprises a fourth switch transistor and a touch driving electrode line, wherein the fourth switch transistor has a gate connected to the touch driving electrode line, a source connected to the drain of the amplification transistor, and a drain connected to the detection sub-circuit.

Exemplarily, the detection sub-circuit comprises: an amplifier, a capacitor across an inverting input terminal and an output terminal of the amplifier, and a switch across the inverting input terminal and the output terminal of the amplifier, wherein the transistor has a drain connected to the inverting input terminal of the amplifier.

Exemplarily, the touch driving electrode line is driven in a way of time division, is used as a touch driving electrode line at a touch stage and is used as a gate line at an image display stage.

Exemplarily, the first reference voltage source is a high level power supply voltage source, and the second reference voltage source is a low level power supply voltage source.

Exemplarily, the first switch transistor, the second switch transistor, the third switch transistor, the fourth switch transistor and the amplification transistor are n type transistors.

The embodiments of the present disclosure provide an optical touch panel comprising the above detection circuit.

The embodiments of the present disclosure further provide a display device comprising the above optical touch panel.

The touch point positioning detection circuit provided in the embodiments of the present disclosure sets in the optical touch sub-circuit a capacitor Cf and a photosensitive capacitor Cs connected with each other in series. The capacitor Cf and the photosensitive capacitor Cs connected in series have an effect of voltage dividing. The photosensitive capacitor Cs is very sensitive to light illuminating, and its capacitance is rapidly increased in a case of light illuminating and is rapidly decreased in a case of no light illuminating. The voltage at the two terminals of the capacitor Cf will be changed by changing the capacitance of the photosensitive capacitor Cs, so as to change the voltage outputted to the detection sub-circuit. The capacitance of the photosensitive capacitor Cs has a greatly large variation before and after light illuminating. Therefore, signals detected by the detection sub-circuit before and after light illuminating also have a large variation, thereby effectively improving the accuracy for the touch point positioning.

### BRIEF DESCRIPTION OF THE DRAWINGS

FIG. 1 is a schematic diagram of a structure of a touch panel touch point positioning detection circuit in the prior art;

FIG. 2 is one schematic diagram of a structure of a touch panel touch point positioning detection circuit provided in an embodiment of the present disclosure;

FIG. 3 is a schematic diagram of voltages at two terminals of a capacitor Cf of the detection circuit as shown in FIG. 2 when a touch occurs and no touch occurs;

FIG. 4 is another schematic diagram of a structure of a touch panel touch point positioning detection circuit provided in an embodiment of the present disclosure;

FIG. 5 is a graph of relation curves of output point voltage Vₒᵤₜ and detection time of a detection sub-circuit provided in an embodiment of the present disclosure before and after light illuminating.

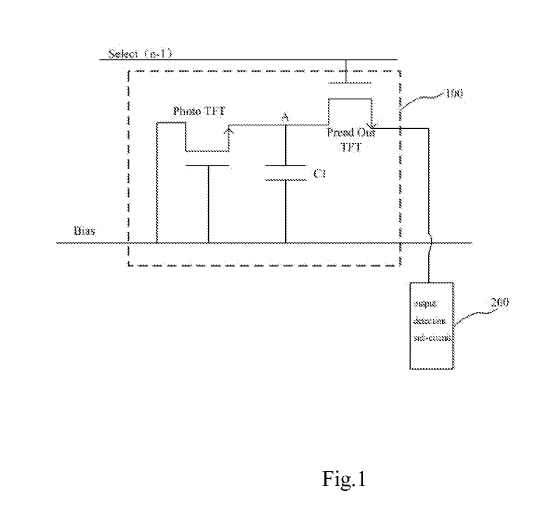

### DETAILED DESCRIPTION

Embodiments of the present disclosure provides a touch point positioning detection circuit, an optical touch panel and a display device, which are used for improving the accuracy for touch point positioning of an optical touch panel.

A photosensitive capacitor is a capacitor being very sensitive to lights. Its capacitance value is rapidly increased under the light illuminating and rapidly decreased without light illuminating, and there is a great variation in capacitance values of the photosensitive capacitor with light illuminating and without light illuminating.

An optical touch sub-circuit of a touch point positioning detection circuit provided in the embodiments of the present disclosure controls a gate voltage of an amplification transistor Tamp in an amplification sub-circuit connected to the optical touch sub-circuit through a capacitor Cf and a photosensitive capacitor Cs connected with each other in series, so as to realize a greater variation in signals detected by an output detection sub-circuit before and after light illuminating the touch display pane and a higher accuracy of the touch point positioning 1.

The technical solution of the embodiments of the present invention is proposed compared with the existing optical touch panel with a relatively lower touch accuracy, and this touch panel is an in cell touch panel.

The embodiments of the present invention realize an optical touch panel with a simple structure and a higher accuracy of touch point positioning by embedding an optical touch sub-circuit for performing touch function and embedding a touch driving electrode line and a touch sensing electrode line for performing touch function in a display panel.

The technical solution provided in the embodiments of the present disclosure will be specified in details in combination with the accompanying drawings.

The touch panel touch point positioning detection circuit provided in the embodiments of the present disclosure can be embedded in a liquid crystal display (LCD) or embedded in an organic light emitting diode (OLED). Moreover, the touch driving electrode line in the touch panel may be a separately set electrode line independent of a gate line, a data line, a common electrode line and so on or may be one of the gate line, the data line and the common electrode line.

The embodiments of the present disclosure will be specified in details below by taking the touch driving electrode line being the gate line as an example.

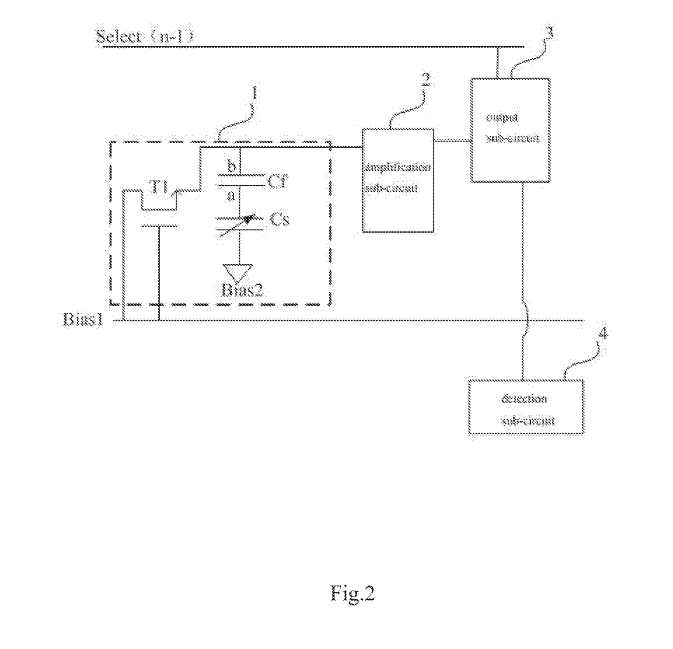

As shown in FIG. 2, the touch point positioning detection circuit provided in the embodiment of the present disclosure comprises:

an optical touch sub-circuit 1 for sensing a touch and generating a touch signal, the touch signal being a touch signal generated due to light illuminating;

an amplification sub-circuit 2 for amplifying the touch signal;

an output sub-circuit 3 for outputting the amplified touch signal;

a detection sub-circuit 4 for detecting a touch point according to the outputted touch signal.

Exemplarily, the optical touch sub-circuit 1 comprises:

a first switch transistor T1, a capacitor Cf and an photosensitive capacitor Cs;

two terminals of the capacitor Cf are terminal a and terminal b respectively;

herein, the first switch transistor T1 has a gate and a source connected to a first reference voltage source V_{reference 1}, and a drain connected to one terminal (terminal b) of the capacitor Cf; the other terminal (terminal a) of the capacitor Cf is connected to one terminal of the photosensitive capacitor Cs, and the other terminal of the photosensitive capacitor Cs is connected to a second reference voltage source V_{reference 2}; and the amplification sub-circuit 2 is connected to a terminal of the capacitor Cf connected to the first switch transistor T1.

The capacitor Cf adopted in the embodiment of the present disclosure may be a fixed capacitor or a variable capacitor.

In a specific implementation process, the touch can be implemented by means of an optical touch pen or a laser pen, and the optical touch sub-circuit 1 senses the touch and generates the touch signal. The optical touch pen or the laser pen can perform the function of realizing the touch through a remote-controlled operation.

In a specific implementation process, the first reference voltage source V_{reference 1} and the second reference voltage source V_{reference 2} can be but not limited to bias voltages of V_{Bias1} and V_{Bias2} provided by a first bias voltage line Bias1 and a second bias voltage line Bias2 as shown in FIG. 2, respectively.

It is needed to specify that a source and a gate of the first switch transistor T1 being simultaneously connected to the first reference voltage source V_{reference 1} is an illustrative embodiment. Such connecting manner can simplify the circuit structure. The source and the gate of the first switch transistor T1 can also be connected to different reference voltage sources, respectively. For example, the source of the first switch transistor T1 may be connected to the first reference voltage source V_{reference 1}, and the gate thereof may be connected to a third reference voltage source V_{reference 3}.

The voltage at the terminal b of the capacitor Cf corresponds to a node voltage V_{b} and the terminal a thereof corresponds to a node voltage Vₐ.

The first switch transistor T1 as shown in FIG. 2 can be an n type transistor or a p type transistor. The operating process of the optical touch sub-circuit will be specified by taking the n type transistor as an example.

When there is no optical touch signal on the touch panel, the photosensitive capacitor Cs has a relatively small capacitance which is set as Cₘᵢₙ; when there is an optical touch signal on the touch panel, the photosensitive capacitor Cs has a relatively large capacitance which is set as Cₘᵢₓ.

When the first bias voltage line Bias1 provides a high level V₁ and the second bias voltage line Bias2 provides a low level V₀, it is set that V₀=0V;

The first switch transistor T1 is switched on, the node b is charged to be close to the high level V₁, the capacitor Cf and the photosensitive capacitor Cs connected in series have an effect of voltage dividing, and a voltage Vₐ at node a is expressed in formula (1):

Vₐ=Cf*V₁/(Cf+Cs) (1)

The capacitance value of the photosensitive Cs varies with the change of having light illumination and without light illumination, and thus an appropriate photosensitive Cs is selected, so that Cf≈Cₘᵢₓ in a case of a preset intensity of light illuminating and Cf>>Cₘᵢₓ in a case of no light illuminating.

When the touch point has no light illuminating, Vₐ₁=Cf*V₁/(Cf+Cₘᵢₙ); Cf>>Cₘᵢₓ, Vₐ₁≈V₁. The photosensitive capacitor Cs almost has no voltage dividing.

When the touch point on the touch panel has light illuminating, Vₐ₂=Cf*V₁/(Cf+Cₘᵢₓ); Vₐ₂≈V₁/2. The voltage across the photosensitive capacitor Cs has a value of V₁/2.

Before and after light illuminating, the values of the voltages at the node b are V_{b1}≈V₁; V_{b2}≈V₁.

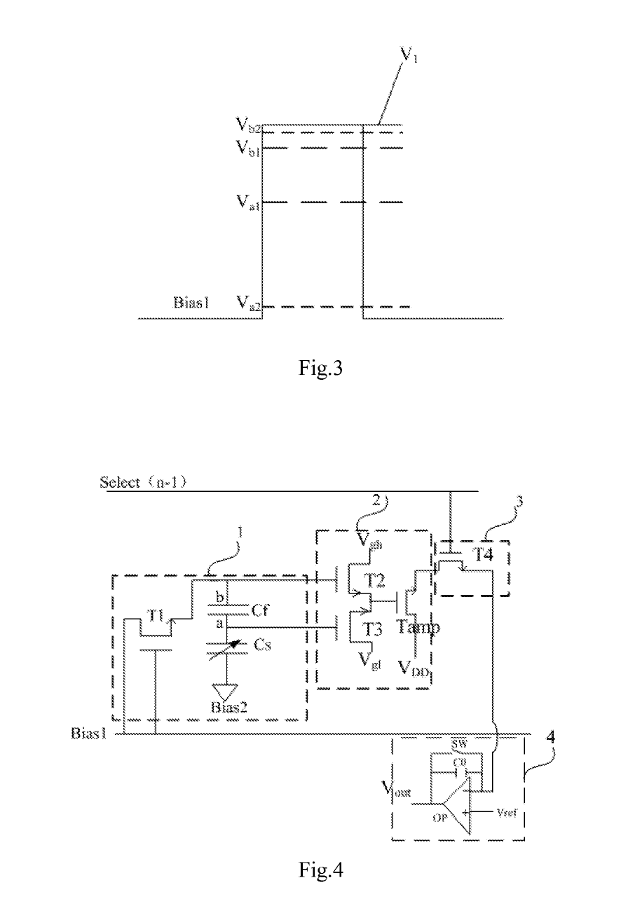

As shown in FIG. 3, when there is no optical touch signal on the touch panel, the voltages at nodes Vₐ and V_{b} are as shown in Vₐ₁ and V_{b1} respectively; when there is an optical touch signal on the touch panel, the voltages at points Vₐ and V_{b} are as shown in Vₐ₂ and V_{b2} respectively. Thus it can be seen that the voltage at node Vₐ is greatly decreased and the voltage at node V_{b} is almost not changed when there is an optical touch signal on the touch panel. Therefore, the voltage difference between Vₐ and V_{b} when there is an optical touch signal on the touch panel has a great increase with respect to that when there is no optical touch signal on the touch panel.

An output voltage Vₒᵤₜ of the output sub-circuit 3 and the detection sub-circuit 4 is related with Vₐ and V_{b}. Before and after there are optical touch signals on the touch panel, the greater the value of Vₐ changes, the greater the value of Vₒᵤₜ changes, and thus there is a higher accuracy for detecting the position of the touch point.

The photosensitive capacitor Cs of the embodiment of the present disclosure has a higher sensitivity than that of an inductive capacitor. When the touch driving electrode and the touch sensing electrode are set at a position in the display panel having a farther distance from the surface of the touch panel, in a case of there being an optical touch signal on the touch panel, the photosensitive capacitor can be very sensitive to detect the occurrence of the optical touch signal, so as to accurately detect the position of the optical touch point.

In addition, one terminal of the photosensitive capacitor Cs is connected to the second bias voltage line Bias2 and the source of the first switch transistor T1 is connected to the first bias voltage line Bias1, which can control the voltage V₀ provided by the second bias voltage line Bias2 to be far smaller than the voltage V₁ provided by the first bias voltage line Bias1, so that before and after there is an optical touch signal on the touch panel, the greater the value of Vₐ changes, the greater the value of Vₒᵤₜ changes, thereby more accurately detecting the position of the touch panel.

The detailed structures of the amplification sub-circuit 2, the output sub-circuit 3 and the detection sub-circuit 4 provided in the embodiment of the present disclosure will be specified by taking examples.

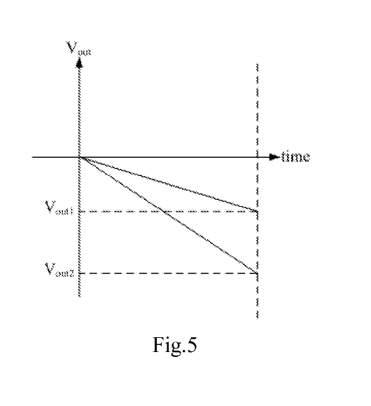

Referring to FIG. 4, the amplification sub-circuit 2 is an amplification sub-circuit with two stages. The amplification sub-circuit 2 comprises: an amplification transistor Tamp, a second switch transistor T2 and a third switch transistor T3. Herein, the second switch transistor T2 has a gate connected to the terminal b of the capacitor Cf, the third switch transistor T3 has a gate connected to the terminal a of the capacitor Cf; the second switch transistor T2 has a drain connected to a drain of the third switch transistor T3 and a source connected to a high level voltage source, corresponding to a voltage V_{gh}, and the third switch transistor T3 has a source connected to a low level voltage source, corresponding to a voltage V_{g1}. The amplification transistor Tamp has a gate connected between the second switch transistor T2 and the third switch transistor T3. When there is an optical touch signal on the touch panel, Vₐ is greatly decreased and the third switch transistor T3 connected to the Vₐ is almost in a switch-off state, while an increase of V_{b} further enhances the switch-on capability of the second switch transistor T2. At this time, the amplification transistor Tamp has a greater gate bias voltage compared with that when there is no optical touch signal occurred on the touch panel.

Referring to FIG. 4, the output sub-circuit 3 comprises a fourth switch transistor T4 and a touch driving electrode line (corresponding to the gate line Select (n−1) in FIG. 4). The fourth switch transistor T4 has a gate connected to the touch driving electrode line, a source connected to the drain of the amplification transistor Tamp, and a drain connected to an input terminal of a detection sub-circuit 4.

It is needed to specify that the touch driving electrode line provided in the embodiment of the present invention can be an electrode line independent of a gate line and a data line and so on, or an electrode line sharing with the gate line, that is, the gate line is driven in a way of time division, is used as the touch driving electrode line in the touch stage and is used as the gate line in the image display stage.

A specification is given below by taking it as an example that the gate line is used as the touch driving electrode line in the touch stage.

Referring to FIG. 4, the detection sub-circuit 4 comprises an amplifier OP, a capacitor CO across an inverting input terminal and an output terminal of the amplifier OP, and a switch SW across the inverting input terminal and the output terminal of the amplifier OP; the touch driving electrode line Select (n−1) (i.e., the (n−1)^{th} gate line) is connected to the inverting input terminal via the output sub-circuit 3.

As shown in FIG. 4, when the touch driving electrode line Select (n−1) is at a high level, before and after there is an optical touch signal occurred on the touch panel within the touch signal detection time, current outputted from the amplification transistor Tamp being flowed to the detection sub-circuit 4 via the output sub-circuit 3 has a great variation, the voltage Vₒᵤₜ outputted from the detection sub-circuit 4 also has a great variation, and thus the touch panel has a high touch accuracy. For example, when there is an optical touch signal on the touch panel, the voltage Vₒᵤₜ outputted from the detection sub-circuit 4 is Vₒᵤₜ₁ (before there is an optical touch signal on the touch panel) and Vₒᵤₜ₂ (after there is a touch signal on the touch panel) respectively. The relation curve of Vₒᵤₜ and detection time is as shown in FIG. 5.

It is needed to specify that the structure of the amplification sub-circuit 2 is not limited to the structure as shown in FIG. 4. For example, the amplification sub-circuit 2 may also be a first stage amplification sub-circuit, particularly comprising: an amplification transistor Tamp, whose gate is connected to the terminal a of the capacitor Cf, source is connected to a high level power supply voltage source, where the high level power supply voltage is V_{DD}, and drain is connected to the output sub-circuit.

Respective transistors provided in the embodiments of the present disclosure, for example, the first switch transistor, the second switch transistor, the third switch transistor, the fourth switch transistor and the amplification transistor, are n type transistors. Gates of the transistors are switched on at the high level and switched off at the low level.

The transistors adopted in the embodiments of the present disclosure may be switch transistors or may be other types of transistors.

This specification just takes the gate line being used as the touch driving electrode line as an example to specify the embodiments of the present disclosure. In a case of the touch driving electrode line of the embodiments of the present disclosure is an electrode line with other functions, the respective transistors are not limited to the n type transistors, but can also be p type transistors.

The embodiments of the present invention provide an optical touch panel which is an in cell touch panel, and comprises a plurality of touch point positioning detection circuits provided in the embodiments of the present disclosure. The number of the touch point positioning detection circuits set in the touch panel and the distance between each other are similar to the prior art, and will not be described repeatedly herein.

The embodiments of the present disclosure further provide a display device, comprising the above optical touch panel. The display device can be a liquid crystal display panel, a liquid crystal display, an organic light emitting diode display OLED panel, and an OLED display and so on which have the touch function.

To sum up, the embodiments of the present disclosure provide an optical touch panel, a touch point positioning detection circuit and a display device for controlling a gate voltage of an amplification transistor Tamp in an amplification sub-circuit connected to the optical touch sub-circuit through a capacitor Cf and a photosensitive capacitor Cs connected with each other in series, so as to realize a greater variation in signals detected by the output detection sub-circuit before and after lights emit the touch display panel and a higher accuracy of the touch point positioning.

Obviously, those skilled in the art can make various alternations and modifications to the present disclosure without departing from the principle of the present disclosure. As such, the present disclosure intends to include these alternations and modifications if they fall into the scope of the claims of the present disclosure and their equivalent technologies.

1. A touch point positioning detection circuit, comprising:
an optical touch sub-circuit for sensing a touch and generating a touch signal;
an amplification sub-circuit connected to the optical touch sub-circuit for amplifying the touch signal;
an output sub-circuit connected to the amplification sub-circuit for outputting the touch signal; and
a detection sub-circuit connected to the output sub-circuit for determining a position of a touch point according to the outputted touch signal.

2. The detection circuit according to claim 1, wherein the optical touch sub-circuit comprises: a first switch transistor, a capacitor and a photosensitive capacitor;
wherein a gate and a source of the first switch transistor are connected to a first reference voltage source, and a drain of the first switch transistor is connected to one terminal of the capacitor;
the other terminal of the capacitor is connected to one terminal of the photosensitive capacitor, and the other terminal of the photosensitive capacitor is connected to a second reference voltage source; and
the amplification sub-circuit is connected to the terminal of the capacitor connected to the first switch transistor.

3. The detection circuit according to claim 1, wherein the amplification sub-circuit comprises a second switch transistor, a third switch transistor and an amplification transistor;
wherein a gate of the second switch transistor is connected to a terminal of the capacitor connected to the first switch transistor, and a gate of the third switch transistor is connected to a terminal of the capacitor connected to the photosensitive capacitor, a drain of the second switch transistor is connected to a drain of the third switch transistor, and a source of the second switch transistor is connected to a high level voltage source;
a source of the third switch transistor is connected to a low level voltage source; and
a gate of the amplification transistor is connected to the drain of the second switch transistor, a drain of the amplification transistor is connected to the output sub-circuit, and a source of the amplification transistor is connected to a high level power supply voltage source.

4. The detection circuit according to claim 3, wherein the output sub-circuit comprises a fourth switch transistor and a touch driving electrode line, wherein a gate of the fourth switch transistor is connected to the touch driving electrode line, a source of the fourth switch transistor is connected to the drain of the amplification transistor, and a drain of the fourth switch transistor is connected to the detection sub-circuit.

5. The detection circuit according to claim 4, wherein the detection sub-circuit comprises: an amplifier, a capacitor across an inverting input terminal and an output terminal of the amplifier, and a switch across the inverting input terminal and the output terminal of the amplifier, a drain of the transistor being connected to the inverting input terminal of the amplifier.

6. The detection circuit according to claim 4, wherein the touch driving electrode line is driven in a way of time division, is used as a touch driving electrode line at a touch stage and is used as a gate line at an image display stage.

7. The detection circuit according to claim 2, wherein the first reference voltage source is a high level power supply voltage source, and the second reference voltage source is a low level supply voltage source.

8. The detection circuit according to claim 4, wherein the first switch transistor, the second switch transistor, the third switch transistor, the fourth switch transistor and the amplification transistor are n type transistors.

9. An optical touch panel comprising the detection circuit according to claim 1.

10. A display device comprising the optical touch panel according to claim 9.

11. The optical touch panel according to claim 9, wherein the optical touch sub-circuit comprises: a first switch transistor, a capacitor and a photosensitive capacitor;
wherein a gate and a source of the first switch transistor are connected to a first reference voltage source, and a drain of the first switch transistor is connected to one terminal of the capacitor;
the other terminal of the capacitor is connected to one terminal of the photosensitive capacitor, and the other terminal of the photosensitive capacitor is connected to a second reference voltage source; and
the amplification sub-circuit is connected to the terminal of the capacitor connected to the first switch transistor.

12. The optical touch panel according to claim 9, wherein the amplification sub-circuit comprises a second switch transistor, a third switch transistor and an amplification transistor;
wherein a gate of the second switch transistor is connected to a terminal of the capacitor connected to the first switch transistor, and a gate of the third switch transistor is connected to a terminal of the capacitor connected to the photosensitive capacitor, a drain of the second switch transistor is connected to a drain of the third switch transistor, and a source of the second switch transistor is connected to a high level voltage source;
a source of the third switch transistor is connected to a low level voltage source; and
a gate of the amplification transistor is connected to the drain of the second switch transistor, a drain of the amplification transistor is connected to the output sub-circuit, and a source of the amplification transistor is connected to a high level power supply voltage source.

13. The optical touch panel according to claim 12, wherein the output sub-circuit comprises a fourth switch transistor and a touch driving electrode line, wherein a gate of the fourth switch transistor is connected to the touch driving electrode line, a source of the fourth switch transistor is connected to the drain of the amplification transistor, and a drain of the fourth switch transistor is connected to the detection sub-circuit.

14. The optical touch panel according to claim 13, wherein the detection sub-circuit comprises: an amplifier, a capacitor across an inverting input terminal and an output terminal of the amplifier, and a switch across the inverting input terminal and the output terminal of the amplifier, a drain of the transistor being connected to the inverting input terminal of the amplifier.

15. The optical touch panel according to claim 13, wherein the touch driving electrode line is driven in a way of time division, is used as a touch driving electrode line at a touch stage and is used as a gate line at an image display stage.

16. The optical touch panel according to claim 11, wherein the first reference voltage source is a high level power supply voltage source, and the second reference voltage source is a low level supply voltage source.

17. The optical touch panel according to claim 13, wherein the first switch transistor, the second switch transistor, the third switch transistor, the fourth switch transistor and the amplification transistor are n type transistors.
